(19) United States
(12) Patent Application Publication
(10) Pub. No.: US 2026/0131823 A1
(43) Pub. Date: May 14, 2026

(54) GROUND SURFACE ESTIMATION USING SENSOR DATA

(71) Applicant: Zoox, Inc., Foster City, CA (US)

(72) Inventor: Kenneth Nathan BROWN, San Carlos, CA (US)

(21) Appl. No.: 19/427,856

(22) Filed: Dec. 19, 2025

Related U.S. Application Data
(63) Continuation-in-part of application No. 18/902,666, filed on Sep. 30, 2024.
Application No. 18/902,666 is a continuation-in-part of application No. 18/787,998, filed on Jul. 29, 2024.
Application No. 18/787,998 is a continuation-in-part of application No. 17/710,855, filed on Mar. 31, 2022, now Pat. No. 12,172,649.

(51) Int. Cl. B60W 60/00; G01S 17/931

(52) U.S. Cl. CPC B60W 60/001; G01S 17/931; B60W 2420/408

(57) ABSTRACT

A first ground surface associated with a first region along a path of a vehicle is obtained and a a plurality of candidate sensor data points associated with a second region along the path is determined based on sensor data from a sensor associated with the vehicle. For a candidate sensor data point a line is determined from the sensor to said data point and it is determined whether the line passes through the first ground surface. Where it is determined that the line passes through the first ground surface, the candidate point is excluded from a ground plane estimation. Where it is determined that the line does not pass through the first ground surface, a second ground surface associated with the second region is determined based on the candidate point. Control of the vehicle is caused based at least in part on the second ground surface.

### RELATED APPLICATIONS

This application is a continuation-in-part under 35 U.S.C. § 120 of U.S. application Ser. No. 18/902,666, filed September 30, 2024, which is a continuation-in-part of U.S. application Ser. No. 18/787,998, filed July 29, 2024, which is a continuation-in-part of U.S. application Ser. No. 17/710,855, filed March 31, 2022, now granted as US Patent No. 12,172,649 on December 24, 2024. Each of the above-referenced patent applications is incorporated by reference in its entirety.

### BACKGROUND

Autonomous vehicles operating on a road network may rely on sensor data to perceive their surrounding environment and make navigation decisions. Ground surface detection and estimation may be performed by autonomous vehicle perception systems to enable the vehicle to distinguish between the road surface and obstacles that may require avoidance or collision mitigation responses.

Ground surface detection during wet road conditions may be affected by reflections caused by puddles or wet surfaces which may cause an incorrect estimate of the ground surface position.

### BRIEF DESCRIPTION OF DRAWINGS

The detailed description is described with reference to the accompanying figures. The use of the same reference numbers in different figures may indicate similar or identical components or features.

FIG. 1 is a pictorial flowchart showing an autonomous vehicle operating in an example environment;

FIG. 2 is a schematic diagram showing an autonomous vehicle operating in an example environment;

FIG. 3 is a schematic diagram showing an autonomous vehicle operating in an example environment;

FIG. 4 is a flow diagram illustrating an example method for causing control of an autonomous vehicle based on a determined ground surface;

FIG. 5 is a block diagram of an example vehicle computing system for implementing the techniques described herein;

FIG. 6 is a block diagram of an example system for implementing the techniques described herein.

### DETAILED DESCRIPTION

The present disclosure provides various techniques for improving ground surface estimation in autonomous vehicle perception systems, specifically, enabling reliable ground fitting in the presence of sensor reflections caused by wet road conditions. These techniques may address challenges in autonomous vehicle perception, such as the potential for reflections from puddles as recorded in various sensors (such as LiDAR) to create false sensor returns that appear below the actual ground surface, which can cause ground-fitting algorithms to incorrectly classify the road surface as an obstacle and/or misclassify actual obstacles (such as pedestrians) as, possibly non-hazardous, objects. The techniques described herein may also enable autonomous vehicles to maintain accurate ground surface estimation across varying environmental conditions, by filtering sensor data points based on ray-casting analysis relative to previously estimated ground surfaces, thereby reducing the likelihood of perception inaccuracies and improving the safety and reliability of autonomous vehicle operation.

Determining accurate ground surfaces in autonomous vehicles may present significant perception system challenges due to the behaviour of sensors and sensor rays in wet conditions. When road surfaces are wet, icy, or hot, outbound sensor rays may reflect off the road surface (e.g., at a puddle) and subsequently off other surfaces (such as vehicles or curbs) before returning to the sensor (as a sensor return), creating the illusion of sensor returns below the actual ground level due to the extended time-of-flight of the reflected sensor ray (also referred to as a signal).

Traditional ground-fitting approaches that process sensor data sequentially along a vehicle’s path may incorporate these erroneous reflection points into ground surface estimations, causing cascading errors in subsequent perception pipeline stages including obstacle detection, tracking, and collision avoidance. This problem may become particularly acute at greater distances from the vehicle where shallow sensor angles make reflection points more prevalent, potentially resulting in degraded perception performance when early detection of distant obstacles may be most valuable for safe trajectory planning and execution.

The techniques described herein may address these challenges through a ray-casting and filtering based method that identifies and excludes reflection-based sensor returns from ground surface estimation by determining whether the ray path from the sensor to a candidate data point (or vice versa) would intersect a previously estimated and validated ground surface. This approach may enable more robust and reliable ground surface detection with improved resistance to environmental conditions by selectively filtering candidate sensor data points based on geometric consistency with prior ground surface determinations, and using the filtered data to generate more accurate ground surface estimates for subsequent regions along the vehicle’s path, thereby improving perception accuracy, reducing false positive obstacle detections, enabling correct classification of actual obstacles, and enhancing overall autonomous vehicle safety.

In addition, the techniques described herein may provide improvements to computational efficiency and processing performance in autonomous vehicle perception systems. By identifying and excluding reflection-based sensor returns early in the perception pipeline, before computationally expensive ground-fitting algorithms are applied, the disclosed techniques reduce the dataset size and computational load required for ground surface estimation. This early-stage filtering prevents the incorporation of erroneous reflection points that would otherwise cause cascading computational errors in subsequent perception pipeline stages, including obstacle detection, tracking, and collision avoidance processing. Such cascading errors would require additional computational resources for error detection, correction, and re-processing.

The approach described herein may be particularly advantageous in resource-constrained safety-critical systems, such as additional systems used for collision avoidance, which may be referred to as a “secondary” system within an autonomous vehicle. Such systems may require fast reaction times and operate with limited computational resources compared to primary autonomous driving systems. Furthermore, the computational efficiency of the filtering technique may increase with distance from the vehicle, as ray angles become shallower and intersection detection becomes more readily determinable, thereby preventing exponential growth in processing requirements for distant regions of the environment. By enabling accurate ground surface detection without requiring additional sensor modalities or computationally expensive machine learning models, the disclosed techniques may facilitate real-time processing at high update rates (e.g., every 100 milliseconds) suitable for the aforementioned secondary system that performs safety-critical autonomous vehicle operation, while reducing overall computational burden on such vehicle computing systems. Such a secondary system may be executed via a physical system or device located within an autonomous vehicle and physically coupled to the primary driving system or may be a virtual system running on a virtual secondary device that is executed by the primary driving system. Both the primary driving system and the secondary system may operate concurrently with one another.

Throughout this disclosure, various terms are used to describe different aspects of stopping location evaluation systems, though should be understood that these terms may be referred to using alternative vocabulary in various contexts, and the definitions provided are intended to be illustrative rather than limiting.

For instance, an “autonomous vehicle” may refer to a fully autonomous or a semi-autonomous vehicle.

For instance, “wet road conditions” may refer to environmental conditions in which moisture is present on a road surface sufficient to cause specular or diffuse reflections of sensor signals, particularly LiDAR returns. Wet road conditions may include, but are not limited to, the presence of puddles, ice, standing water, rain-dampened surfaces, or other moisture on the road that creates reflective surfaces, causing sensor returns to reflect from the road surface to other objects (such as vehicles, curbs, barriers, or buildings) before returning to the sensor. In some examples, wet road conditions may be caused by non-environmental factors such as spillage on the road of a liquid or material that has a reflective property, such as oil, fuel, hydraulic fluid, coolant, or any other liquid or semi-liquid material that creates a reflective surface capable of causing similar reflection artifacts in sensor data. Wet road conditions may be detected by environmental sensors (e.g., LiDAR-based environment monitors, cameras, moisture sensors) associated with the vehicle or may be inferred from the presence of anomalous sensor returns that exhibit characteristics consistent with reflection artifacts, as described herein. In some instances, “wet road conditions” may refer to the appearance (rather than presence) of moisture of a road surface, for example, due to varying air densities resulting from a high temperature of the road surface and heat dissipating from the road surface to the surrounding air.

For instance, a “bin” (or ‘spatial bin’) may refer to a discrete spatial region along a path or trajectory of a vehicle, typically defined by a segment length (such as approximately one meter) and associated with a particular distance range along the path. Bins may be used to organize sensor data spatially to facilitate sequential ground surface estimation as the vehicle progresses along its trajectory. In some examples, a bin may be associated with a spatial region around the path that defines lateral extents in addition to the longitudinal segment.

For instance, an “estimated ground surface” may refer to a computational approximation of the actual topography of the ground along a path or trajectory of an autonomous vehicle. The estimated ground surface may be determined based at least in part on sensor data points that are classified as ground returns and may be represented as a geometric construct such as a plane, curve, spline, or series of discrete ground points. In some instances, an estimated ground surface may be a previously estimated ground surface associated with a preceding region or bin along the path, enabling sequential construction of ground surfaces as an autonomous vehicle progresses along its trajectory.

For instance, a “ray” may refer to a sensor signal that travels or is projected to travel along a straight line path between two points, or from one point towards a second point, in three-dimensional space, particularly the path from a sensor to a candidate sensor data point, or vice versa. “Ray-casting” may refer to the computational technique of determining such a ray and analyzing its geometric relationship with other objects or surfaces in the environment, such as determining whether the ray intersects a previously estimated ground surface. In the context of lidar or other time-of-flight sensors, a ray may represent the presumed direct path that electromagnetic radiation traveled from the sensor to a point in the environment and back to the sensor.

For instance, a “candidate sensor data point” (or “candidate point”) may refer to a sensor data point under evaluation to determine whether it should be included in or excluded from ground surface estimation. A candidate sensor data point may be associated with a particular spatial region (such as a bin) along a vehicle’s path and may be evaluated based on geometric criteria, such as whether a ray or line from the sensor to the candidate point intersects a previously estimated ground surface.

For instance, a “reflection” or “reflection artifact” may refer to an erroneous sensor return caused by specular or diffuse reflection of a sensor signal (such as LiDAR light) from a reflective surface (such as a wet road surface or puddle) to another object in the environment before returning to the sensor. Because the sensor measures only the total time-of-flight and cannot detect intermediate reflections, reflection artifacts may appear as sensor data points at incorrect locations, often appearing below the actual ground surface due to the extended path length.

For instance, a spatial region of the environment associated with a vehicle’s path or trajectory may be defined by a width extending laterally from the path and a length extending longitudinally along the path. Said spatial region associated with the path or trajectory of the vehicle may be determined based at least in part on vehicle dimensions (such as vehicle width), trajectory characteristics (such as planned steering angles), safety margins, and/or other factors. The spatial region associated with a path or trajectory of a vehicle may define the spatial region within which sensor data is analyzed for ground surface determination and obstacle detection, enabling focused processing of relevant sensor data while reducing computational burden.

For instance, an “intersection point” may refer to the location in three-dimensional space where a ray (such as a line from a sensor to a candidate sensor data point) crosses or passes through a surface (such as a previously estimated ground surface). Determining an intersection point may comprise calculating the coordinates where a line intersects a plane, curve, or other geometric representation of a ground surface. The position of an intersection point relative to the sensor and candidate sensor data point along the ray may be used to determine whether the ray passes through the ground surface, which may indicate that the candidate sensor data point represents a reflection artifact.

For instance, a “path” or “trajectory” may refer to a planned route or course of travel for a vehicle through an environment. A trajectory may comprise a sequence of positions, headings, velocities, and/or controls such as steering angles, steering rates, and/or accelerations that define how the vehicle should move over time or distance. A path may define a geometric route through space that the vehicle plans to follow. In some examples, the terms “path” and “trajectory” may be used interchangeably to refer to the planned course of vehicle motion along which ground surface estimation and sensor data analysis is performed. A path or trajectory may be determined by a planning component of the vehicle based on perception data, map data, destination information, and/or other factors.

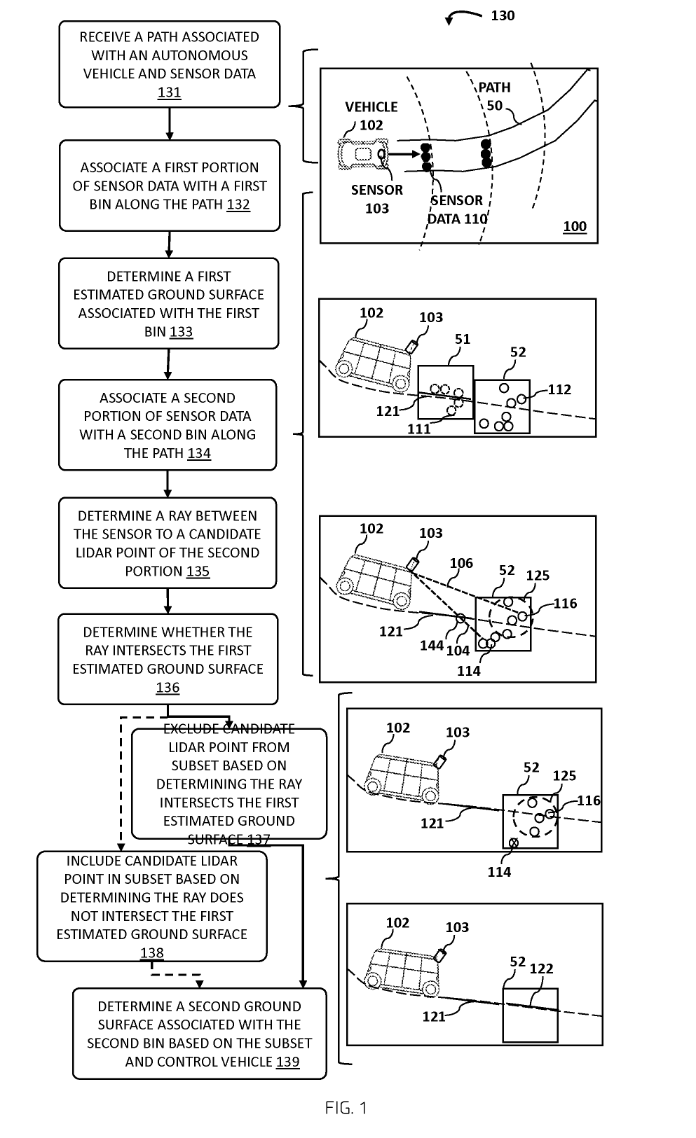

Various aspects of the techniques will now be described with regards to FIG. 1, which illustrates an example scenario 100 involving an autonomous vehicle 104.

FIG. 1 illustrates a pictorial flow diagram of a method 130 for filtering sensor data 110 to improve ground surface detection based at least in part on sensor data received at an autonomous vehicle 102 while excluding inaccurate sensor data points that result from reflections. The method 130 enables accurate ground surface determination even in challenging conditions such as wet road surfaces where reflections can cause erroneous sensor returns.

At step 131, the method 130 may comprise receiving a path 50 associated with controlling the autonomous vehicle 102 through an environment 100, according to any of the techniques discussed herein. The path 50 may represent a trajectory or route determined by a planning component of the autonomous vehicle 102.

Step 131 may also comprise receiving sensor data 110 from a sensor 103 associated with the autonomous vehicle 102, according to any of the techniques discussed herein. For instance, the sensor data 110 may comprise LIDAR and/or radar data, among other types of sensor data. The techniques may be used for a variety of sensor data types and may not be limited to light-based sensors. In some instances, the sensor data 110 may comprise depth data (e.g., data indicating a distance from the sensor 103/autonomous vehicle 102 to a surface in the environment), Doppler data associated with detected surfaces, and/or any other type of sensor data that indicates the position of objects in the environment surrounding the autonomous vehicle 102.

At step 132, the method 130 may comprise associating a first portion of the sensor data 111 with a first bin 51, the first bin 51 being associated with a first distance along the path 50. The first bin 51 may represent a spatial region along the path 50, for instance, approximately one meter in length. The first portion of sensor data 111 may include all sensor data points that fall within the first bin 51 (e.g., are associated with a longitudinal distance between zero and one meter in front of the vehicle).

At step 133, the method 130 may comprise determining, based at least in part on the first portion of sensor data 111, a first estimated ground surface 121 associated with the first bin 51. The first estimated ground surface 121 may have been determined using sensor data associated with the first bin 51. The first estimated ground surface 121 may serve as a reference for filtering sensor data points in subsequent bins along the path 50. Determining a ground profile estimate using maximum and minimum slopes of bins is disclosed in US 2025018954 A1 and US 2024383482 A1, which are incorporated herein by reference in their entirety and for all purposes.

At step 134, the method 130 may comprise associating a second portion of the sensor data 112 with a second bin 52, the second bin 52 being associated with a second distance along the path 50. The second bin 52 may be further along the path 50 than the first bin 51 and may be associated with another segment of the path 50. For instance, the second bin 52 may be approximately one meter further along the path 50 than the first bin 51 (e.g., between 1m and 2m in front of the vehicle). The second portion of sensor data 112 may include all sensor data points that fall within the second bin 52.

At step 135, method 130 may comprise, for a candidate sensor data point 114 of the second portion of sensor data 112, determining a first ray 104 from the sensor 103 to the candidate sensor data point 114.

At step 136, the method 130 may comprise determining whether the first ray 104 intersects the first estimated ground surface 121. Where it is determined that the first ray 104 passes through the first estimated ground surface 121, this indicates that the light or other radiation would have had to pass through the ground to reach the first candidate sensor point 114 location, which is physically impossible for a direct return. Therefore, such a candidate sensor data point must represent a reflection, where the radiation bounced off the ground surface (e.g., off a puddle) and then off another object before returning to the sensor 103. In some examples, as part of step 136, an intersection point 144 may be calculated where the first ray 104 intersects the first estimated ground surface 121. It may be determined that the first ray 104 passes through the first estimated ground surface 121 when the intersection point 144 lies on the ray 104 between the sensor 103 and the first candidate sensor point 114.

At step 137, the method 130 may comprise, where it is determined that the first ray 104 intersects the first estimated ground surface 121, excluding the candidate sensor data point 114 from a subset 125 of the second portion of sensor data 112. Excluding the first candidate sensor point 114 may include masking, deleting, or down-weighting such a sensor data point. In at least some examples, the first candidate sensor point 114 may be reflected about the plane or line associated with the ground plane as estimated or otherwise associated with the intersection point 144 and associated with a potential object or surface and likelihood or certainty thereof.

As an alternative to step 137, at step 138, the method 130 may comprise, where it is determined that the first ray 104 does not intersect the first estimated ground surface 121, including the candidate sensor data point in the subset 125 of the second portion of sensor data 112. In the example of FIG. 1, a second candidate sensor point 116 may represent another sensor data point within the second portion of sensor data 112. A second ray 106 may be determined extending from the sensor 103 to the second candidate sensor point 116. It may be determined that the second ray 106 does not intersect the first estimated ground surface 121, which indicates that the second candidate sensor point 116 is likely a valid sensor return. Accordingly, the second candidate sensor point 116 may be included in the subset 125 of sensor data points.

The subset 125 may comprise all candidate sensor data points from the second portion of sensor data 112 that have been determined to be valid based on the ray-casting analysis with respect to previously estimated ground surfaces, such as the first estimate ground surface 121, described above.

At step 139, the method 130 may comprise determining a second ground surface 122 associated with the second bin 52 based on the subset 125 of the second portion of sensor data 112. The second ground surface 122 may represent an accurate estimation of the road surface at the second bin 52, with reflection artifacts having been filtered out.

Step 139 may further comprise controlling the autonomous vehicle 102 based at least in part on the second ground surface 122. Controlling the autonomous vehicle 102 based at least in part on the second ground surface 122 may include classifying sensor data as being associated with a ground classification or an object classification using the second ground surface 122. For instance, sensor data within a threshold distance of the second ground surface 122 may be associated with the ground classification and other sensor data that doesn’t meet this criteria and has an elevation greater than the second ground surface 122 may be classified as being associated with an object. Based on the classification of objects in the environment, the vehicle may validate or reject a planned trajectory, determine a new trajectory, execute a contingent trajectory such as a safe stop maneuver, or continue executing the planned trajectory. The second ground surface 122, determined without the influence of inaccurate reflection data, enables more accurate object detection and safer vehicle control.

In the example of FIG. 1, determining an estimated ground surface (such as the surfaces 121 and 122) may comprise fitting a line or plane to the first portion of sensor data 111 using techniques such as least squares regression, weighted least squares, Hough transform, or other curve fitting algorithms.

In some instances, method 130 may be conducted iteratively, with the second ground surface 122 becoming the first estimated ground surface for a subsequent iteration that determines a third ground surface associated with a third bin further along the path 50. This iterative process enables the vehicle to build an accurate ground profile along the entire path 50 or trajectory by progressively excluding inaccurate sensor data caused by reflections.

The techniques illustrated in FIG. 1 may provide several technical advantages over conventional ground surface detection approaches. By filtering out reflection-based sensor data points before ground surface estimation, the techniques may prevent ground-fitting algorithms from incorrectly biasing toward lower elevations, thereby maintaining accurate ground surface detection even in wet road conditions where reflections are prevalent. This improved accuracy in ground surface detection may reduce false positive obstacle detections where the road surface itself is incorrectly identified as an obstacle, and may also prevent misclassification of actual obstacles (such as pedestrians or vehicles) as overhead objects or non-hazardous features. Adopting a ray-casting (defined above) approach may lead to computational efficiencies, as it leverages previously estimated ground surfaces to filter subsequent sensor data without requiring additional sensor modalities or complex machine learning models. Furthermore, the sequential binning approach may enable real-time processing at high update rates (e.g., every 100 milliseconds) suitable for safety-critical collision avoidance systems, while the effectiveness of the filtering may increase with distance from the vehicle as ray angles become shallower and intersections with prior ground surfaces become more readily detectable.

In some examples, each sensor data point of the second portion of sensor data 112 may be evaluated, as described above in relation to step 136, concurrently, through use of parallel processing capabilities (such as with general purpose graphics processing unit (GPGPU), tensor processing units, FPGAs, ASICs, or the like) of the vehicle 102.

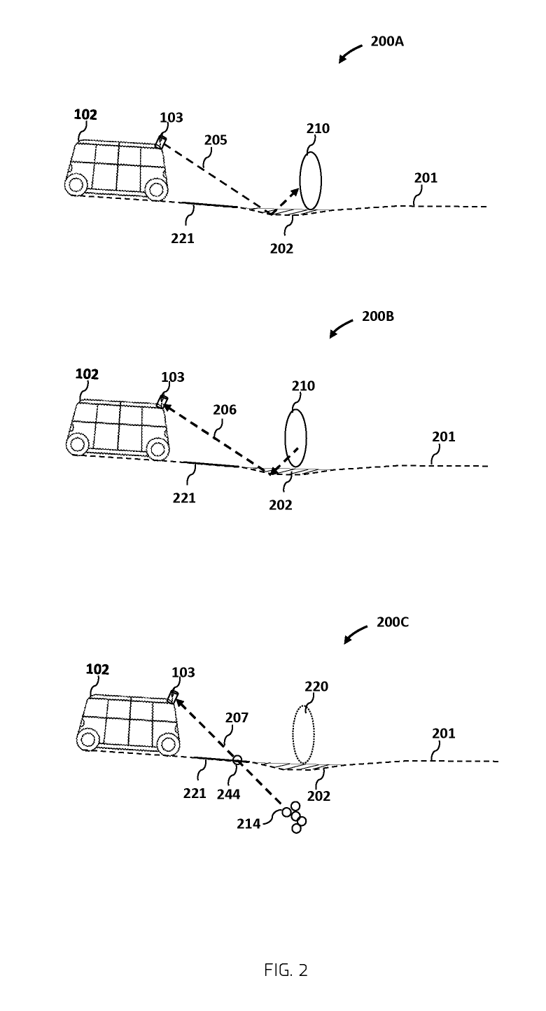

FIG. 2 illustrates an example scenario in a series of three sequential snapshots 200A, 200B, and 200C that depict lidar reflection from wet road surfaces and the techniques for utilizing reflected sensor data to identify potential obstacle locations. The scenario illustrates the vehicle 102 of FIG. 1 comprising the sensor 103 positioned on a road 201, with a wet surface area 202 and an object 210 in the environment. A first ground surface 221 has been previously estimated according to the techniques discussed herein.

In the first snapshot 200A, an outbound ray 205 is emitted from the sensor 103 toward the road 201. The outbound ray 205 encounters the wet surface area 202, which may comprise a puddle or other reflective surface on the road. Rather than being absorbed or scattered, the outbound ray 205 is reflected by the wet surface area 202 and redirected toward object 210, which may be a vehicle, curb, pedestrian, or other obstacle in the environment.

Next, in the second snapshot 200B, the outbound ray 205 (not shown) is reflected by the object 210 as a return ray 206. The return ray 206 travels back toward the wet surface area 202 and is then reflected back to the sensor 103, completing the round-trip path of the lidar signal.

Then, in the third snapshot 200C, the sensor 103 processes the return ray 206 and, based on the total time of flight, incorrectly determines that the return ray 206 travelled in a straight line originating from a candidate sensor point 214 that appears to be located below the first ground surface 221. This is shown as perceived return ray 207, in the form of the straight-line path that the sensor 103 determines that the return ray 206 traveled. The perceived return ray 207 intersects the first ground surface 221 at intersection point 244. Because the candidate sensor point 214 appears below the previously estimated first ground surface 221, and because the perceived return ray 207 must pass through the first ground surface 221 to reach the candidate sensor point 214, the system may identify this as a reflection artifact that is an erroneous sensor return, according to the techniques discussed herein.

According to the techniques discussed herein, the system may project the candidate sensor point 214 to a location above the intersection point 244 to identify a potential obstacle 220. This projection may be performed by reflecting the candidate sensor point 214 across the first ground surface 221 at the intersection point 244, by reflecting the candidate sensor point 214 to a location symmetrically positioned above the first ground surface 221 relative to the intersection point 244, or by using the geometry of the reflection to estimate the actual location of object 210. By projecting the candidate sensor point 214 in this manner, the system may utilize what would otherwise be discarded reflection data to improve obstacle detection, particularly in situations where direct sensor returns from the object 210 may be sparse or insufficient for confident object classification.

In this way, the vehicle 102 may maintain accurate perception even under challenging wet road conditions, where reflections might otherwise degrade perception performance. By identifying reflections through intersection analysis and then repurposing those reflections to identify obstacle locations, the system improves both ground surface estimation and object detection/avoidance capabilities to make the vehicle safer to operate and the system uses the reflection related data that would otherwise be discarded as not being useful.

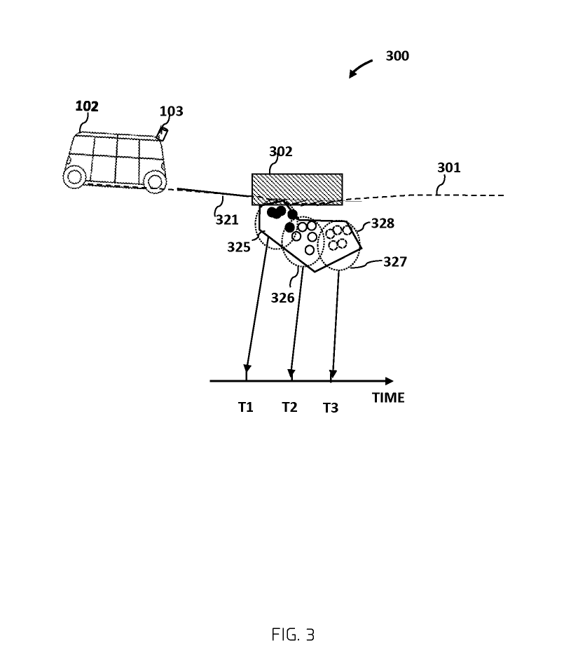

FIG. 3 is a schematic diagram showing an autonomous vehicle (the autonomous vehicle 102 of FIGS. 1 and 2) operating in an example environment 300.

The vehicle 102 comprises the sensor 103 and is positioned on a road 301. As the vehicle 102 operates along the road 301, the sensor 103 may continuously generate sensor data representing detected points in the environment. According to the techniques discussed herein, the vehicle 102 may determine a first ground surface 321 based on sensor data associated with a first region along a path of the vehicle 102. The first ground surface 321 may serve as a reference for filtering subsequent sensor data points as described herein.

During operation of the vehicle 102, candidate sensor data points may be evaluated by determining whether a ray or line from the sensor 103 to each candidate sensor data point passes through the first ground surface 321, as described in relation to FIG. 1.

The scenario 300 illustrates how excluded sensor data points may be aggregated over time to identify one or more persistent reflection areas. At a first time T1, the vehicle 102 may identify a first portion of excluded sensor data points 325. The first portion of excluded sensor data points 325 may comprise candidate sensor data points that were excluded from ground surface estimation because respective rays from the sensor 103 to these points passed through the first ground surface 321. The locations of the excluded sensor data points in the first portion 325 may be stored in memory associated with the vehicle 102.

At a second time T2, which occurs after the first time T1, the vehicle 102 may identify a second portion of excluded sensor data points 326. The second portion of excluded sensor data points 326 may similarly comprise candidate sensor data points that were excluded from ground surface estimation.

At a third time T3, which occurs after the second time T2, the vehicle 102 may identify a third portion of excluded sensor data points 327 that were excluded from ground surface estimation. The vehicle 102 may aggregate the locations of the excluded sensor data points in the first, second and third portions (325, 326, 327) of excluded sensor data points to determine an area 328 in which excluded sensor data points repeatedly occur. Of course, though illustrated with respect to the excluded sensor data points, the same or similar analysis may be made based on the associated intersection points (e.g., the associated reflecting region may correspond to the portion of the environment associated with the intersection points). By aggregating the locations of excluded sensor data points over time, the vehicle 102 may identify an above-ground spatial region associated with the road 301 that corresponds to the area 328, said spatial region referred to herein as a persistent reflection area 302.

The persistent reflection area 302 may represent a region on the road 301 that corresponds to the area 328, where excluded sensor data points have been consistently identified over multiple time periods, which may indicate that the persistent reflection area 302 contains a reflective surface feature, such as standing water, that causes the excluded sensor data points. In some examples, the vehicle 102 may compare the number of aggregated excluded sensor data points in a given area to a predetermined threshold to determine whether there is a sufficient number of excluded sensor data points in said area that indicates a persistent reflection area. In addition, or as an alternative, the number of excluded data points within a portion of data points associated with a given time or the number of different portions within a given area containing excluded data points may be compared to a predetermined threshold prior to said portion(s) being aggregated with any other portion. In this way, the vehicle 102 may identify above ground spatial regions associated with from the same or substantially overlapping areas from which excluded sensor data points persistently originate.

The vehicle 102 may determine a likelihood of a puddle being associated with the persistent reflection area 302. Determining the likelihood may be based at least in part on one or more factors, including: the number of excluded sensor data points within the persistent reflection area 302; the temporal consistency of excluded sensor data points (e.g., whether excluded points occur consistently over time); the spatial extent of the persistent reflection area 302; environmental condition data indicating whether the road surface is wet or dry; and/or other contextual information such as weather conditions, recent precipitation, or historical puddle locations.

In some instances, the vehicle 102 may maintain a spatial map or grid representation of the environment, wherein each cell or region of the map stores information about excluded sensor data points detected in that region over time. As new excluded sensor data points are identified, their locations may be added to the appropriate cells in the map, and a persistence metric may be updated for each cell based on the frequency and recency of excluded sensor data points.

Of course, though described for illustrative purposes as a single vehicle and as discussed in greater detail below, it should be appreciated that the various times indicated may correspond to data received from any one or more additional vehicles in a fleet of vehicles. In such examples, estimated points from reflection may be associated with a region by the one or more additional vehicles and information regarding the region (e.g., boundary, associated points, number of points, time of day, time of year, etc.) may be uploaded to a server to be aggregated into a map with associated uncertainty for use by all vehicles in the fleet. Combining data from multiple vehicles may improve the accuracy and confidence of puddle detection, as multiple independent observations of the same persistent reflection area may provide stronger evidence of an actual puddle.

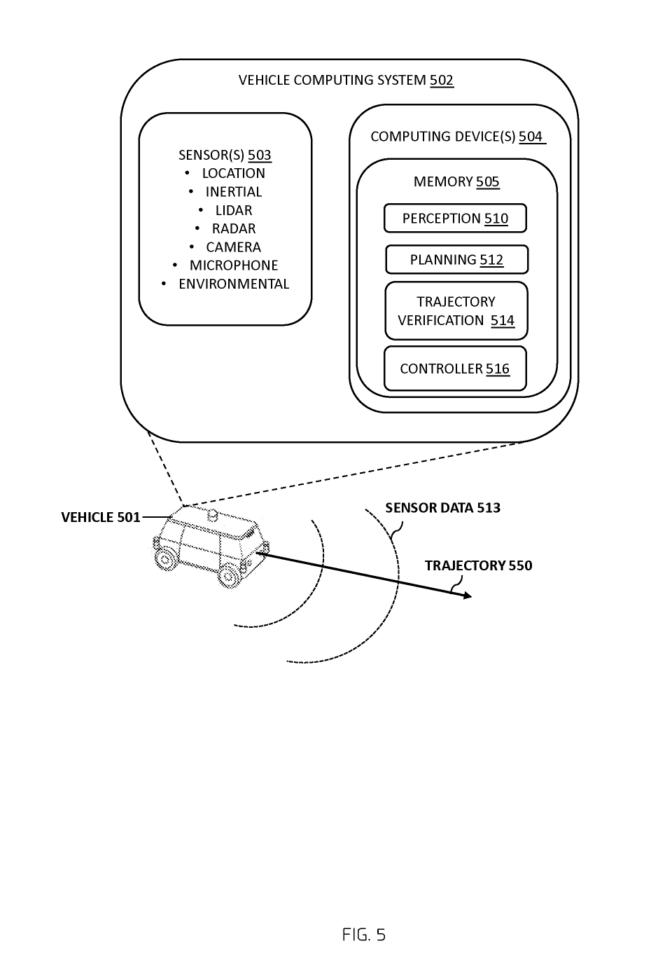

In some examples, the aggregation of excluded sensor data points described in relation to FIG. 3 may be performed on-vehicle by a vehicle computing system associated with the vehicle 102. The vehicle computing system is described in more detail in relation to FIG. 5.

In some instances, the vehicle 102 may send data associated with the persistent reflection area 302 and/or the likelihood of a puddle to a remote computing system associated with a plurality of vehicles. For instance, the vehicle 102 may transmit, via network interface(s) of its computing system, information identifying the location of the persistent reflection area 302, the likelihood of a puddle being associated with the persistent reflection area 302, and/or other relevant data such as the confidence level of the determination, the time period over which the data was collected, and environmental conditions at the time of detection.

The remote computing system may comprise one or more servers, cloud computing nodes, or other computing infrastructure configured to receive and aggregate puddle detection data from multiple vehicles in a fleet. The remote computing system may maintain a map database that stores information about detected puddles and persistent reflection areas across a road network.

The data associated with the persistent reflection area 302 and the likelihood of a puddle may be made accessible to the plurality of vehicles in the fleet. For instance, other vehicles may query the remote computing system and/or the map database for puddle information along their planned routes, or the remote computing system may proactively transmit puddle location data to vehicles approaching areas with known puddles. By sharing puddle detection data across the fleet, vehicles may adjust their behavior in advance of encountering puddles, such as by reducing speed, adjusting trajectory to avoid the puddle, or modifying sensor processing parameters to account for expected reflections.

In some instances, the likelihood of a puddle may be represented as a probability value, a confidence score, or a categorical classification (e.g., “low likelihood,” “medium likelihood,” “high likelihood”). The likelihood determination may be updated over time as additional data is collected. For instance, if excluded sensor data points continue to be detected in the persistent reflection area 302 over an extended time period or across multiple vehicle passes, the likelihood of a puddle may be increased. Conversely, if excluded sensor data points cease to be detected in the persistent reflection area 302, the likelihood may be decreased, indicating that the puddle may have dried or that the reflective condition has changed.

The techniques illustrated in FIG. 3 provide several technical advantages. By aggregating excluded sensor data points over time, the system can distinguish between transient reflection artifacts and persistent reflective features that occur due to features in a road (such as a pothole, crevice, or other gap) that are shaped in such a way that enables a fluid – such as rainwater as puddles or spilled liquid - to collect. This temporal analysis improves the robustness of fluid detection compared to single-frame analysis. The identification of persistent reflection areas enables the vehicle to build a spatial understanding of road surface conditions, which can inform path planning, speed control, and sensor parameter adjustment. By sharing fluid (e.g., puddle) detection data across a fleet of vehicles via a remote computing system, the techniques enable collaborative environmental mapping and allow vehicles to benefit from observations made by other vehicles, improving overall fleet safety and efficiency. The fluid detection capability may also provide valuable data for road maintenance authorities, as persistent puddles or repeated fluid collection in an area may indicate drainage problems or road surface defects that require attention.

In some examples, the system may adjust a tolerance for determining whether a line or ray passes through a previously estimated ground surface based on environmental condition data. The tolerance may define a threshold distance from the ground surface within which a ray intersection is considered to occur. Environmental condition data may be received from environmental sensors associated with the vehicle, such as LiDAR-based environment monitors, cameras with moisture detection capabilities, temperature sensors, or dedicated road condition sensors.

When environmental condition data indicates dry road conditions, the system may increase the tolerance value, thereby reducing the sensitivity of the reflection filtering. For instance, in dry conditions where reflections are less likely to occur, the tolerance may be set to a first threshold distance (e.g., 1 centimeter, 2 centimeters, or 3 centimeters). A candidate sensor data point whose ray comes within this first threshold distance of the first ground surface may be included in ground surface estimation rather than being excluded, as the likelihood of the point representing a reflection artifact is reduced in dry conditions.

Conversely, when environmental condition data indicates wet road conditions, the system may decrease the tolerance value, thereby increasing the sensitivity of the reflection filtering. For instance, in wet conditions where reflections are more likely due to the presence of puddles or moisture on the road surface, the tolerance may be set to a second threshold distance that is smaller than the first threshold distance (e.g., 0.5 centimeters, 0.2 centimeters, or zero). This reduced tolerance results in more aggressive filtering of candidate sensor data points whose rays pass through or near the first ground surface, as such points are more likely to represent reflection artifacts in wet conditions.

The adjustment of tolerance based on environmental conditions may improve the accuracy and robustness of ground surface estimation across varying weather conditions. In dry conditions, the increased tolerance may prevent the erroneous exclusion of valid sensor data points that may be subject to normal sensor noise, thereby maintaining adequate sensor data for ground surface determination. In wet conditions, the decreased tolerance may more effectively filter reflection artifacts, preventing the ground surface estimation from being biased downward by reflected sensor returns. The tolerance values may be predetermined and stored in memory, or may be dynamically calculated based on factors such as the degree of wetness indicated by the environmental condition data, recent precipitation levels, or historical reflection detection rates.

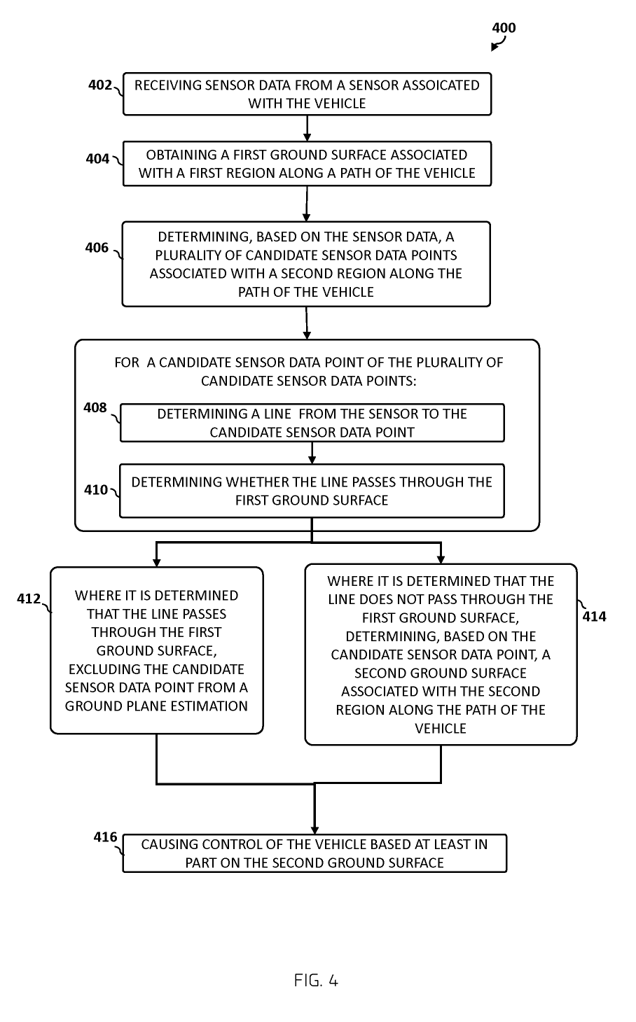

FIG. 4 is a flow diagram illustrating an example method 400 for controlling an autonomous vehicle, such as vehicle 102 described in relation to FIGS. 1-3. The method 400 may be performed by a vehicle computing system (such as the vehicle computing system 502 of FIG. 5), a remote computing system or a combination of the two. The example the method 400 enables accurate ground surface determination even in challenging conditions such as wet road surfaces where reflections can cause erroneous sensor returns.

At step 402, the method 400 may comprise receiving sensor data from a sensor associated with a vehicle, according to any of the techniques discussed herein.

At step 404, the method 400 may comprise obtaining a first ground surface associated with a first region or bin along a path of the vehicle. The first ground surface may have been previously determined using sensor data associated with the first region, which may be closer to the vehicle than a second region for which a ground surface is being determined. In some instances, the first ground surface may be determined based at least in part on an initial segment near the vehicle position, from which subsequent ground surfaces may be determined as the method 400 proceeds along the path.

At step 406, the method 400 may comprise determining, based on the sensor data, a plurality of candidate sensor data points associated with a second region along the path of the vehicle. The second region may be further along the path than the first region and may be associated with a bin or segment of the path. For instance, the second region may be approximately one meter further along the path than the first region

At step 408, the method 400 may comprise, for a candidate sensor data point of the plurality of candidate sensor data points, determining a line from the sensor to the candidate sensor data point. The line may represent the path that light or other electromagnetic radiation traveled from the sensor to the point in the environment that generated the sensor return, and back to the sensor. In some instances, determining the line may comprise determining a vector from the sensor position to the position indicated by the candidate sensor data point.

At step 410, the method 400 may comprise, for the candidate sensor data point of step 408, determining whether the line passes through the first ground surface. This determination may identify whether the sensor return associated with the candidate sensor data point could have been a direct return from a surface in the environment, or whether it must have been a reflection.

At step 412, the method 400 may comprise, where it is determined that the line passes through the first ground surface, excluding the candidate sensor data point from a ground plane estimation.

At step 414, which may be performed as an alternative to step 412, the method 400 may comprise, where it is determined that the line does not pass through the first ground surface, determining, based on the candidate sensor data point, a second ground surface associated with the second region along the path of the vehicle. The second ground surface may be determined based at least in part on all candidate sensor data points in the second region whose lines do not pass through the first ground surface

At step 416, the method 400 may comprise causing control of the vehicle based at least in part on the second ground surface. Controlling the vehicle based at least in part on the second ground surface may include classifying sensor data as being associated with a ground classification or an object classification using the second ground surface. Based on the classification of objects in the environment, the vehicle may validate or reject a planned trajectory, determine a new trajectory, execute a contingent trajectory such as a safe stop maneuver, or continue executing the planned trajectory. The second ground surface, determined without the influence of inaccurate reflection data, enables more accurate object detection and safer vehicle control.

In some instances, the method 400 may be conducted iteratively, with the second ground surface becoming the first ground surface for a subsequent iteration that determines a third ground surface associated with a third region further along the path. This iterative process enables the vehicle to build an accurate ground profile along the entire path or trajectory by progressively excluding inaccurate sensor data caused by reflections.

FIG. 5 is a schematic diagram of an example vehicle computing system 502 of an autonomous vehicle 501. The vehicle 501 may correspond to the autonomous vehicle 102 described in relation to FIGS. 1-4.

According to the techniques discussed herein, the vehicle 501 may receive sensor data 513 from sensor(s) 503 of the vehicle 501. The sensor(s) 503 may include depth position sensors (e.g., lidar sensors, radar sensors, sonar sensors, time of flight (ToF) cameras, depth cameras, ultrasonic sensors), location sensors (e.g., GPS sensors), inertial sensors (e.g., accelerometer sensors, gyroscope sensors), image sensors (e.g., cameras), and/or environmental sensors (e.g., barometers, hygrometers).

The sensor(s) 503 may generate sensor data 513, which may be received by computing device(s) 504 associated with the vehicle 501. Computing device(s) 504 may comprise a memory 505 storing a perception component 510, a planning component 512, a trajectory verification component 514, and system controller(s) 516.

The perception component 510 may determine what is in the environment surrounding the vehicle 501, and the planning component 512 may determine how to operate the vehicle 501 according to information received from the perception component 510. The planning component 512 may determine trajectory 550 based at least in part on perception data and/or other information such as maps and localization information. The trajectory 550 may comprise instructions for controller(s) 516 to actuate drive components of the vehicle 501.

The trajectory verification component 514 may implement the ground surface filtering techniques discussed herein. The trajectory verification component 514 may receive the trajectory 550 from the planning component 512 and determine a spatial region associated with the trajectory based at least in part on a current velocity of the vehicle 501, a velocity specified by the trajectory 550, a distance in front of the vehicle, a width of the vehicle, and/or an offset. The trajectory verification component 514 may determine a subset of the sensor data 513 associated with the spatial region and conduct ground surface estimation operations based on the subset.

The trajectory verification component 514 may determine a ground profile associated with the subset of sensor data. The ground profile may be a line, curve, or plane fitted to the subset of sensor data. In some examples, the trajectory verification component 514 may reduce dimensionality of the subset of sensor data to determine the ground profile by projecting the subset into a space defined by the trajectory.

The trajectory verification component 514 may identify and exclude inaccurate sensor data from ground profile determination according to the ray-casting techniques discussed herein. For example, the trajectory verification component 514 may determine a ray between the sensor and a candidate lidar point and determine whether the ray intersects a previously estimated ground surface. Inaccurate sensor data caused by reflections from wet road surfaces may be identified when lidar light bounces off puddles and then reflects off other objects before returning to the sensor. The trajectory verification component 514 may determine a filtered subset of sensor data that excludes inaccurate sensor data points identified through ray intersection analysis.

The trajectory verification component 514 may classify sensor data into ground or object classifications. The trajectory verification component 514 may determine whether to validate or reject the trajectory 550 based on the ground surface determination and object classifications. Validating the trajectory 550 may comprise transmitting the trajectory 550 to the controller(s) 516. Rejecting the trajectory 550 may comprise transmitting a message to the planning component 512 to initiate re-determining a trajectory and/or initiating an alternate maneuver, such as a safe stop maneuver or a contingent trajectory.

The controller(s) 516 may comprise software and/or hardware for actuating drive components of the vehicle 501 sufficient to track the trajectory 550. For example, the controller(s) 516 may comprise one or more proportional-integral-derivative (PID) controllers.

While the vehicle computing system 502 is illustrated as being located entirely within the autonomous vehicle 501, in some implementations, portions of the vehicle computing system 502 may be distributed across multiple computing systems. In such implementations, the vehicle 501 may transmit data to a remote computing system that processes the data and returns results to the vehicle 501. A remote computing system may be in communication with the vehicle computing system 502 and may be operated by a human operator.

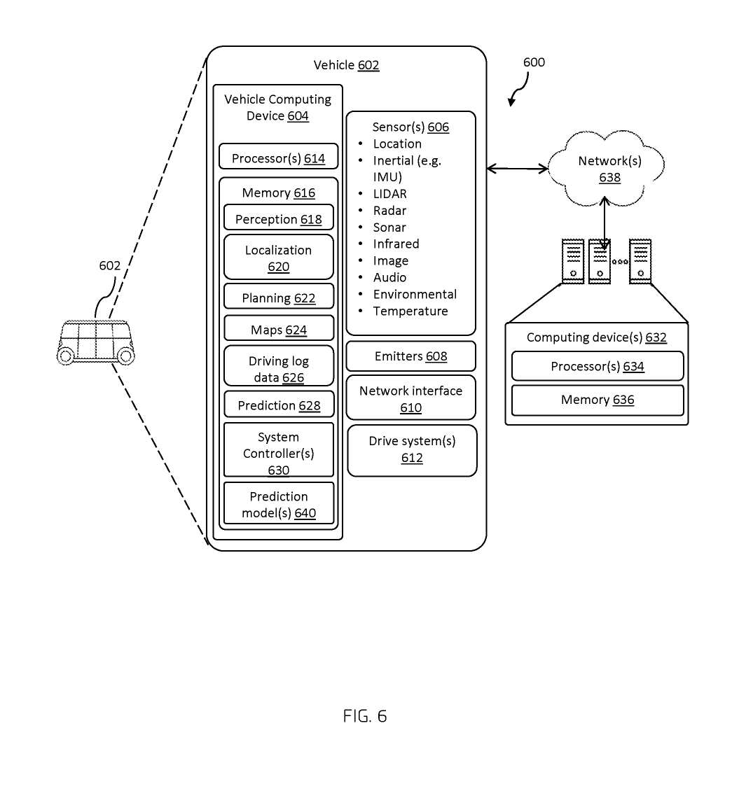

FIG. 6 illustrates a block diagram of an example system 600 that implements the techniques discussed herein. FIG. 6 may represent the autonomous vehicle 102 of FIGS. 1-3, the vehicle 501 of FIG. 5 and the described computing system 502 of FIG. 5. In some instances, the example system 600 may include a vehicle 602. In some instances, the vehicle 602 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 602 may be a fully or partially autonomous vehicle having any other level or classification. Moreover, in some instances, the techniques described herein may be usable by non-autonomous vehicles as well.

The vehicle 602 may include a vehicle computing device(s) 604, sensor(s) 606, emitter(s) 608, network interface(s) 610, and/or drive system(s) 612. The system 600 may additionally or alternatively comprise computing device(s) 622. In some instances, the sensor(s) 606 may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 606 may include multiple instances of each of these or other types of sensors. For instance, the radar sensors may include individual radar sensors located at the corners, front, back, sides, and/or top of the vehicle 602. As another example, the cameras may include multiple cameras disposed at various locations about the exterior and/or interior of the vehicle 602. The sensor(s) 606 may provide input to the vehicle computing device(s) 604 and/or to computing device(s) 632.

The vehicle 602 may also include emitter(s) 608 for emitting light and/or sound, as described above. The emitter(s) 608 may include interior audio and visual emitter(s) to communicate with passengers of the vehicle 602. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 608 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 602 may also include network interface(s) 610 that enable communication between the vehicle 602 and one or more other local or remote computing device(s). The network interface(s) 610 may facilitate communication with other local computing device(s) on the vehicle 602 and/or the drive component(s) 612. The network interface(s) 610 may additionally or alternatively allow the vehicle to communicate with other nearby computing device(s) (e.g., other nearby vehicles, road signals, etc.). The network interface(s) 610 may additionally or alternatively enable the vehicle 602 to communicate with computing device(s) 632 over a network 638. In some examples, computing device(s) 632 may comprise one or more nodes of a distributed computing system (e.g., a cloud computing architecture).

The vehicle 602 may include one or more drive components 612. In some instances, the vehicle 602 may have a single drive component 612. In some instances, the drive component(s) 612 may include one or more sensors to detect conditions of the drive component(s) 612 and/or the surroundings of the vehicle 602. By way of example and not limitation, the sensor(s) of the drive component(s) 612 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 612. In some cases, the sensor(s) on the drive component(s) 612 may overlap or supplement corresponding systems of the vehicle 602 (e.g., sensor(s) 606).

The drive component(s) 612 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 612 may include a drive component controller which may receive and pre-process data from the sensor(s) and to control operation of the various vehicle systems. In some instances, the drive component controller may include one or more processors and memory communicatively coupled with the one or more processors. The memory may store one or more components to perform various functionalities of the drive component(s) 612. Furthermore, the drive component(s) 612 may also include one or more communication connection(s) that enable communication by the respective drive component with one or more other local or remote computing device(s).

The vehicle computing device(s) 604 may include processor(s) 614 and memory 616 communicatively coupled with the one or more processors 614. Computing device(s) 632 may also include processor(s) 634, and/or memory 636. The processor(s) 614 and/or 634 may be any suitable processor capable of executing instructions to process data and perform operations as described herein. By way of example and not limitation, the processor(s) 614 and/or 634 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 616 and/or 636 may be examples of non-transitory computer-readable media. The memory 616 and/or 636 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 616 and/or memory 636 may store a perception component 618, localization component 620, planning component 622, map(s) 624, driving log data 626, prediction component 628, and/or system controller(s) 630—zero or more portions of any of which may be hardware, such as GPU(s), CPU(s), and/or other processing units.

The perception component 618 may detect object(s) in in an environment surrounding the vehicle 602 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 618 is referred to as perception data. The perception component 618 may be configured to associate a bounding region (or other indication) with an identified object. The perception component 618 may be configured to associate a confidence score associated with a classification of the identified object with an identified object. In some examples, objects, when rendered via a display, can be colored based on their perceived class. The object classifications determined by the perception component 618 may distinguish between different object types such as, for example, a passenger vehicle, a pedestrian, a bicyclist, motorist, a delivery truck, a semi-truck, road signage, and/or the like.

In at least one example, the localization component 620 may include hardware and/or software to receive data from the sensor(s) 606 to determine a position, velocity, and/or orientation of the vehicle 602 (e.g., one or more of an x-, y-, z-position, roll, pitch, or yaw). For example, the localization component 620 may include and/or request/receive map(s) 624 of an environment and can continuously determine a location, velocity, and/or orientation of the autonomous vehicle 602 within the map(s) 624. In some instances, the localization component 620 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 620 may provide data to various components of the vehicle 602 to determine an initial position of an autonomous vehicle for generating a trajectory and/or for generating map data, as discussed herein. In some examples, localization component 620 may provide, to the perception component 618, a location and/or orientation of the vehicle 602 relative to the environment and/or sensor data associated therewith.

The planning component 622 may receive a location and/or orientation of the vehicle 602 from the localization component 620 and/or perception data from the perception component 618 and may determine instructions for controlling operation of the vehicle 602 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 630 and/or drive component(s) 612 may parse/cause to be carried out, second instructions for the emitter(s) 608 may be formatted according to a second format associated therewith).

The driving log data 626 may comprise sensor data, perception data, and/or scenario labels collected/determined by the vehicle 602 (e.g., by the perception component 618), as well as any other message generated and or sent by the vehicle 602 during operation including, but not limited to, control messages, error messages, etc. In some examples, the vehicle 602 may transmit the driving log data 626 to the computing device(s) 632.

The prediction component 628 may generate one or more probability maps representing prediction probabilities of possible locations of one or more objects in an environment. For example, the prediction component 628 may generate one or more probability maps for vehicles, pedestrians, animals, and the like within a threshold distance from the vehicle 602. In some examples, the prediction component 628 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 622 may be communicatively coupled to the prediction component 628 to generate predicted trajectories of objects in an environment. For example, the prediction component 628 may generate one or more predicted trajectories for objects within a threshold distance from the vehicle 602. In some examples, the prediction component 628 may measure a trace of an object and generate a trajectory for the object based on observed and predicted behavior. Although prediction component 628 is shown on a vehicle 602 in this example, the prediction component 628 may also be provided elsewhere, such as in a remote computing device. In some examples, a prediction component may be provided at both a vehicle and a remote computing device. These components may be configured to operate according to the same or a similar algorithm.

The memory 616 and/or 636 may additionally or alternatively store a mapping system, a planning system, a ride management system, etc. Although perception component 618 and/or planning component 622 are illustrated as being stored in memory 616, perception component 618 and/or planning component 622 may include processor-executable instructions, machine-learned model(s) (e.g., a neural network), and/or hardware.

As described herein, the localization component 620, the perception component 618, the planning component 622, and/or other components of the system 600 may comprise one or more ML models. For example, the localization component 620, the perception component 618, and/or the planning component 622 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,1533, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 616 may additionally or alternatively store one or more system controller(s) 630, which may be configured to control steering, propulsion, braking, safety, emitters, communication, and other systems of the vehicle 602. These system controller(s) 630 may communicate with and/or control corresponding systems of the drive component(s) 612 and/or other components of the vehicle 602.

It should be noted that while FIG. 6 is illustrated as a distributed system, in alternative examples, components of the vehicle 602 may be associated with the computing device(s) 632 and/or components of the computing device(s) 632 may be associated with the vehicle 602. That is, the vehicle 602 may perform one or more of the functions associated with the computing device(s) 632, and vice versa.

Various modifications and adaptations may be implemented.

### EXAMPLE CLAUSES:

A: A system comprising: one or more processors; and one or more non-transitory computer-readable media storing computer executable instructions that, when executed, cause the one or more processors to perform operations comprising: receiving a path associated with controlling an autonomous vehicle through an environment; receiving sensor data from a sensor associated with the autonomous vehicle; associating a first portion of the sensor data with a first bin, the first bin associated with a first distance along the path; determining, based at least in part on the first portion of the sensor data, a first estimated ground surface associated with the first bin; associating a second portion of the sensor data with a second bin, the second bin associated with a second distance along the path; determining a ray between the sensor to a candidate lidar point of the second portion of the sensor data; determining whether the ray intersects the first estimated ground surface; and one of: excluding the candidate lidar point from a subset of the second portion of the sensor data based at least in part on determining the ray intersects the first estimated ground surface, or including the candidate lidar point in the subset of the second portion of the sensor data based at least in part on determining the ray does not intersect the first estimated ground surface; determining a second ground surface associated with the second bin based on the subset of the second portion of the sensor data; and controlling the autonomous vehicle based on the second ground surface.

B: A system as clause A describes, wherein the ray intersects the first ground surface, the operations further comprising: determining an intersection point where the ray intersects the first ground surface; and projecting the candidate lidar point to a location above the intersection point to identify a potential obstacle location.

C: A system as any of clauses A-B describe, the operations further comprising: aggregating locations of excluded candidate lidar points over time to identify a persistent reflection area; and determining a likelihood of a puddle being associated with the persistent reflection area.

D: A system as any of clauses A-C describe, the operations further comprising: detecting an object based at least in part on the second ground surface; and controlling the autonomous vehicle based on the object.

E: A method comprising: receiving sensor data from a sensor associated with a vehicle; obtaining a first ground surface associated with a first region along a path of the vehicle; determining, based on the sensor data, a plurality of candidate sensor data points associated with a second region along the path of the vehicle; for a candidate sensor data point of the plurality of candidate sensor data points: determining a line from the sensor to the candidate sensor data point; and determining whether the line passes through the first ground surface; where it is determined that the line passes through the first ground surface, excluding the candidate sensor data point from a ground plane estimation; where it is determined that the line does not pass through the first ground surface, determining, based on the candidate sensor data point, a second ground surface associated with the second region along the path of the vehicle; and causing control of the vehicle based at least in part on the second ground surface.

F: A method as clause E describes, wherein the candidate sensor data point is a first candidate sensor data point and the method further comprises: for a second candidate sensor data point of the plurality of candidate sensor data points, determining a second line from the sensor to the second candidate sensor data point; determining that the second line does not pass through the first ground surface; and determining, based at least in part on the second candidate sensor data point, the second ground surface.

G: A method as any of clauses E-F describe, further comprising: representing the first ground surface as a ground plane; calculating an intersection point between the line and the ground plane; and determining that the line passes through the first ground surface when the intersection point lies between the sensor and the candidate sensor data point along the line.

H: A method as any of clauses E-G describe, further comprising: where it is determined that the line passes through the first ground surface, determining an intersection point where the line passes through the first ground surface; and projecting the candidate sensor data point to a location above the intersection point to identify a potential obstacle location.

I: A method as any of clauses E-H describe, further comprising: where it is determined that the line passes through the first ground surface, aggregating a location of the candidate sensor data point with other candidate sensor data points associated with respective lines that pass through the first ground surface to generate a subset of candidate sensor data points; identifying, based at least in part on the subset of candidate data points, a likelihood of a persistent reflection area.

J: A method as any of clauses E-I describe, further comprising: detecting an object based at least in part on the second ground surface; and causing control of the vehicle based on the object.

K: A method of any of clauses E-J describe, further comprising: receiving environmental condition data indicating whether a road surface is wet or dry; and adjusting a tolerance for determining whether the line passes through the first ground surface based on the environmental condition data.

L: A method as any of clauses E-K describe, wherein the sensor data comprises at least one of: lidar data; and radar data.

M: A method of any of clauses E-I describe, further comprising: sending the likelihood of a persistent reflection area to a computing system associated with a plurality of vehicles, such that data associated with the likelihood of a persistent reflection area is accessible to the plurality of vehicles.

N: One or more non-transitory computer-readable media storing instructions that, when executed, cause one or more processors to perform operations comprising: receiving sensor data from a sensor associated with a vehicle; obtaining a first ground surface associated with a first region along a path of the vehicle; determining, based on the sensor data, a plurality of candidate sensor data points associated with a second region along the path of the vehicle; for a candidate sensor data point of the plurality of candidate sensor data points: determining a line from the sensor to the candidate sensor data point; and determining whether the line passes through the first ground surface; where it is determined that the line passes through the first ground surface, excluding the candidate sensor data point from a ground plane estimation; where it is determined that the line does not pass through the first ground surface, determining, based on the candidate sensor data point, a second ground surface associated with the second region along the path of the vehicle; and causing control of the vehicle based at least in part on the second ground surface.

O: The one or more non-transitory computer-readable media of clause N describes, wherein the candidate sensor data point is a first candidate sensor data point and the operations further comprise: for a second candidate sensor data point of the plurality of candidate sensor data points, determining a second line from the sensor to the second candidate sensor data point; determining that the second line does not pass through the first ground surface; and determining, based at least in part on the second candidate sensor data point, the second ground surface.

P: The one or more non-transitory computer-readable media of as any one of clauses O-N describe, the operations further comprising: representing the first ground surface as a ground plane; calculating an intersection point between the line and the ground plane; and determining that the line passes through the first ground surface when the intersection point lies between the sensor and the candidate sensor data point along the line.

Q: The one or more non-transitory computer-readable media as any one of clauses O-P describe, the operations further comprising: where it is determined that the line passes through the first ground surface, determining an intersection point where the line passes through the first ground surface; and projecting the candidate sensor data point to a location above the intersection point to identify a potential obstacle location.

R: The one or more non-transitory computer-readable media as any one of clauses O-Q describe, the operations further comprising: where it is determined that the line passes through the first ground surface, aggregating a location of the candidate sensor data point with other candidate sensor data points associated with respective lines that pass through the first ground surface to generate a subset of candidate sensor data points; identifying, based at least in part on the subset of candidate data points, a likelihood of a persistent reflection area.

S: The one or more non-transitory computer-readable media of as any one of clauses O-R describe, the operations further comprising: detecting an object based at least in part on the second ground surface; and causing control of the vehicle based on the object.

T: The one or more non-transitory computer-readable media of as any one of clauses O-S describe, the operations further comprising: receiving environmental condition data indicating whether a road surface is wet or dry; and adjusting a tolerance for determining whether the line passes through the first ground surface based on the environmental condition data.

While the example clauses described above are described with respect to one particular implementation, it should be understood that, in the context of this document, the content of the example clauses can also be implemented via a method, device, system, computer-readable medium, and/or another implementation. Additionally, any of clauses A-Z. may be implemented alone or in combination with any other one or more of the clauses A-Z.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer executable instructions that, when executed, cause the one or more processors to perform operations comprising:
receiving a path associated with controlling an autonomous vehicle through an environment;
receiving sensor data from a sensor associated with the autonomous vehicle;
associating a first portion of the sensor data with a first bin, the first bin associated
with a first distance along the path;
determining, based at least in part on the first portion of the sensor data, a first estimated ground surface associated with the first bin;
associating a second portion of the sensor data with a second bin, the second bin
associated with a second distance along the path;
determining a ray between the sensor to a candidate lidar point of the second portion
of the sensor data;
determining whether the ray intersects the first estimated ground surface; and
one of:
excluding the candidate lidar point from a subset of the second portion of the sensor data based at least in part on determining the ray intersects the first estimated ground surface, or
including the candidate lidar point in the subset of the second portion of the sensor data based at least in part on determining the ray does not intersect the first estimated ground surface;
determining a second ground surface associated with the second bin based on the subset of the second portion of the sensor data; and
controlling the autonomous vehicle based on the second ground surface.

2. The system of claim 1, wherein the ray intersects the first ground surface, the operations further comprising:
determining an intersection point where the ray intersects the first ground
surface; and
projecting the candidate lidar point to a location above the intersection point to identify a potential obstacle location.

3. The system of claim 1, the operations further comprising:
aggregating locations of excluded candidate lidar points over time to identify a persistent reflection area; and
determining a likelihood of a puddle being associated with the persistent reflection area.

4. The system of claim 1, the operations further comprising:
detecting an object based at least in part on the second ground surface; and
controlling the autonomous vehicle based on the object.

5. A method comprising:
receiving sensor data from a sensor associated with a vehicle;
obtaining a first ground surface associated with a first region along a path of the vehicle;
determining, based on the sensor data, a plurality of candidate sensor data points associated with a second region along the path of the vehicle;
for a candidate sensor data point of the plurality of candidate sensor data points:
determining a line from the sensor to the candidate sensor data point; and
determining whether the line passes through the first ground surface;
where it is determined that the line passes through the first ground surface, excluding the candidate sensor data point from a ground plane estimation;
where it is determined that the line does not pass through the first ground surface, determining, based on the candidate sensor data point, a second ground surface associated with the second region along the path of the vehicle; and
causing control of the vehicle based at least in part on the second ground surface.

6. The method of claim 5, wherein the candidate sensor data point is a first candidate sensor data point and the method further comprises:
for a second candidate sensor data point of the plurality of candidate sensor data points,
determining a second line from the sensor to the second candidate sensor data
point;
determining that the second line does not pass through the first ground surface; and
determining, based at least in part on the second candidate sensor data point, the second ground surface.

7. The method of claim 5, further comprising:
representing the first ground surface as a ground plane;
calculating an intersection point between the line and the ground plane; and
determining that the line passes through the first ground surface when the intersection point lies between the sensor and the candidate sensor data point along the line.

8. The method of claim 5, further comprising:
where it is determined that the line passes through the first ground surface,
determining an intersection point where the line passes through the first ground surface; and
projecting the candidate sensor data point to a location above the intersection point to identify a potential obstacle location.

9. The method of claim 5, further comprising:
where it is determined that the line passes through the first ground surface,
aggregating a location of the candidate sensor data point with other candidate sensor data points associated with respective lines that pass through the first ground surface to generate a subset of candidate sensor data points;
identifying, based at least in part on the subset of candidate data points, a likelihood of a persistent reflection area.

10. The method of claim 5, further comprising:
detecting an object based at least in part on the second ground surface; and
causing control of the vehicle based on the object.

11. The method of claim 5, further comprising:
receiving environmental condition data indicating whether a road surface is wet or dry; and
adjusting a tolerance for determining whether the line passes through the first ground surface based on the environmental condition data.

12. The method of claim 5, wherein the sensor data comprises at least one of:
lidar data; and
radar data.

13. The method of claim 9, further comprising:
sending the likelihood of a persistent reflection area to a computing system associated with a plurality of vehicles, such that data associated with the likelihood of a persistent reflection area is accessible to the plurality of vehicles.

14. One or more non-transitory computer-readable media storing instructions that, when executed, cause one or more processors to perform operations comprising:
receiving sensor data from a sensor associated with a vehicle;
obtaining a first ground surface associated with a first region along a path of the vehicle;
determining, based on the sensor data, a plurality of candidate sensor data points associated with a second region along the path of the vehicle;
for a candidate sensor data point of the plurality of candidate sensor data points:
determining a line from the sensor to the candidate sensor data point; and
determining whether the line passes through the first ground surface;
where it is determined that the line passes through the first ground surface, excluding the candidate sensor data point from a ground plane estimation;
where it is determined that the line does not pass through the first ground surface, determining, based on the candidate sensor data point, a second ground surface associated with the second region along the path of the vehicle; and
causing control of the vehicle based at least in part on the second ground surface.

15. The one or more non-transitory computer-readable media of claim 14, wherein the candidate sensor data point is a first candidate sensor data point and the operations further comprise:
for a second candidate sensor data point of the plurality of candidate sensor data points, determining a second line from the sensor to the second candidate sensor data point;
determining that the second line does not pass through the first ground surface; and
determining, based at least in part on the second candidate sensor data point, the second ground surface.

16. The one or more non-transitory computer-readable media of claim 14, the operations further comprising:
representing the first ground surface as a ground plane;
calculating an intersection point between the line and the ground plane; and
determining that the line passes through the first ground surface when the intersection point lies between the sensor and the candidate sensor data point along the line.

17. The one or more non-transitory computer-readable media of claim 14, the operations further comprising:
where it is determined that the line passes through the first ground surface, determining an intersection point where the line passes through the first ground surface; and
projecting the candidate sensor data point to a location above the intersection point to identify a potential obstacle location.

18. The one or more non-transitory computer-readable media of claim 14, the operations further comprising:
where it is determined that the line passes through the first ground surface, aggregating a location of the candidate sensor data point with other candidate sensor data points associated with respective lines that pass through the first ground surface to generate a subset of candidate sensor data points;
identifying, based at least in part on the subset of candidate data points, a likelihood of a persistent reflection area.

19. The one or more non-transitory computer-readable media of claim 14, the operations further comprising:
detecting an object based at least in part on the second ground surface; and
causing control of the vehicle based on the object.

20. The one or more non-transitory computer-readable media of claim 14, the operations further comprising:
receiving environmental condition data indicating whether a road surface is wet or dry; and
adjusting a tolerance for determining whether the line passes through the first ground surface based on the environmental condition data.
